(19) United States
(12) Patent Application Publication
(10) Pub. No.: US 2023/0351407 A1
(43) Pub. Date: Nov. 2, 2023

(54) SYSTEM AND METHOD FOR PRODUCT CERTIFICATION MANAGEMENT

(71) Applicant: Walmart Apollo, LLC, Bentonville, AR (US)

(72) Inventors: Lingyun Hu, Brooklyn, NY (US); Anand Banik, Rogers, AR (US); Harika Addagada, Bentonville, AR (US); Coran J. Coley, Bentonville, AR (US); Zachary Bell, Rogers, AR (US); Pushparaj Parab, Bentonville, AR (US); Haritha Gunawardana, Piscataway, NJ (US); Weihong Ou, Bentonville, AR (US)

(21) Appl. No.: 18/142,495

(22) Filed: May 2, 2023

Related U.S. Application Data
(60) Provisional application No. 63/337,538, filed on May 2, 2022.

(51) Int. Cl. G06Q 30/018; G06Q 20/38

(52) U.S. Cl. CPC G06Q 30/018; G06Q 20/38215; G06Q 20/3825; G06Q 2220/00

(57) ABSTRACT

Method and system for product certification management are provided. A method for product certification management comprises communicating with a plurality of other nodes of the supply chain distributed ledger, identifying, with a product certification management module, a transaction identifier in a transaction record in the supply chain distributed ledger, retrieving transaction metadata associated with the transaction identifier from the supply chain distributed ledger, verifying one or more applicable certifications for the transaction identifier based on the transaction metadata and the plurality of certificate records in the supply chain distributed ledger, the plurality of certificate records each comprising certification metadata and a pointer to a certificate document stored in a certification documents database, and generating certificate verification record comprising a reference to the transaction record and a reference to one or more certificate records associated with the one or more applicable certifications.

### CROSS-REFERENCE TO RELATED APPLICATION

This application claims the benefit of U.S. Provisional Application No. 63/337,538, filed May 2, 2022, which is incorporated by reference in its entirety herein.

### TECHNICAL FIELD

This invention relates generally to product certification management and particularly to automatic product certification verification based on a distributed ledger.

### BACKGROUND

Environmental, social, and corporate governance (ESG) is an approach to evaluating the extent to which a corporation works on behalf of social goals. The social goals advocated within an ESG perspective may include environmental goals, goals having to do with supporting certain social movements, and goals having to do with whether the corporation is governed in a way that is consistent with the goals of diversity, equity, and inclusion movement. Various government regulatory and non-government agencies issue ESG certificates based on their respective criteria. In a supply chain, ESG certification and ratings may be issued for various supply chain entities as well as product components and end products.

### BRIEF DESCRIPTION OF THE DRAWINGS

Disclosed herein are embodiments of systems and methods for providing automatic product certification management. This description includes drawings, wherein:

FIG. 1 comprises a block diagram of a system in accordance with some embodiments;

FIG. 2 comprises a flow diagram of a process in accordance with some embodiments;

FIG. 3 comprises a flow diagram of a process in accordance with some embodiments;

FIG. 4 comprises a flow diagram of a process in accordance with some embodiments;

FIG. 5 comprises an illustration of blocks of a distributed ledger as configured in accordance with some embodiments;

FIG. 6 comprises an illustration of transaction records configured in accordance with some embodiments;

FIG. 7 comprises a flow diagram in accordance with some embodiments;

FIG. 8 comprises a process diagram as configured in accordance with some embodiments;

FIG. 9 comprises an illustration of a delivery record configured in accordance with some embodiments; and

FIG. 10 comprises a system diagram configured in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Generally speaking, pursuant to various embodiments, systems, devices, and methods are provided for product certification management based on a distributed ledger. In one embodiment, a system for product certification management comprises a network interface, a user interface device, and a control circuit coupled to the network interface and the user interface device. The control circuit executes a product certification management module that is configured to communicate, as a node of a supply chain distributed ledger and via the network interface, with a plurality of other nodes of the supply chain distributed ledger corresponding to a plurality of entities in a supply chain, wherein the supply chain distributed ledger comprises a plurality of transaction records and a plurality of certificate records, identify a transaction identifier in a transaction record in the supply chain distributed ledger, retrieve transaction metadata associated with the transaction identifier from the supply chain distributed ledger, verify one or more applicable certifications for the transaction identifier based on the transaction metadata and the plurality of certificate records in the supply chain distributed ledger, the plurality of certificate records each comprising certification metadata and a pointer to a certificate document stored in a certification documents database, and generate, as an update to the supply chain distributed ledger, a certificate verification record comprising a reference to the transaction record and a reference to one or more certificate records associated with the one or more applicable certifications.

In some embodiments, the methods and systems described herein provide the ability to issue, store, and manage ESG certification with shared visibility across internal and external network participants over a distributed database such as a blockchain. The system provides a document upload interface for uploading certificate documents (i.e. via Portable Document Format (PDF)) such as environmental, social, and corporate governance (ESG) certificates. The system further provides a digital document (e.g., PDF) stamping service which associates uploaded documents with transaction IDs to safeguard against duplicate/counterfeit documentation.

In some embodiments, the system utilizes smart contracts to associate product instance/batch (instance level master data (ILMD)) in a distributed ledger with certificates. Products may generally be products offered for sale by retailers or wholesalers in-store or through ecommerce channels. In some embodiments, the system includes a certificate verification authority, which may be a retailer system, that provides digital certification to sign transactions with transaction ID and block ID. In some embodiments, the system utilizes a shared document storage system (e.g., interplanetary file system (IPFS) for distributed storage among network participants. In some embodiments, the system provides a front-end application that provides users with read access to verified transaction ID & block ID.

In some embodiments, the systems and methods described herein provide an end-to-end scalable production system to store and manage ESG certificates that associate certified documents with instance-level master data (ILMD), such as a lot/batch, to enable more granular traceability and auditability of certifications. The systems and methods also provide the ability to view certificate history to track issuance, expiration, and renewal dates.

In some embodiments, the systems and methods described herein provide trusted ESG certificate management and sharing for imported products that may require certificate sharing for up to 40+ government agencies (i.e. FDA, EPA, USDA) and may reduce third-party auditor fees using signed ESG documents with transaction and block ID, including expiration and renewal date history. In some embodiments, the systems and methods further provide consumer experience of certificate visibility to drive brand recognition and sales for certified products (i.e. sustainably grown, responsibly sourced, organic). In some embodiments, the system may also be used to manage other types of documents such as regulatory agency compliance documents (e.g. phytosanitary certificate) associated with products.

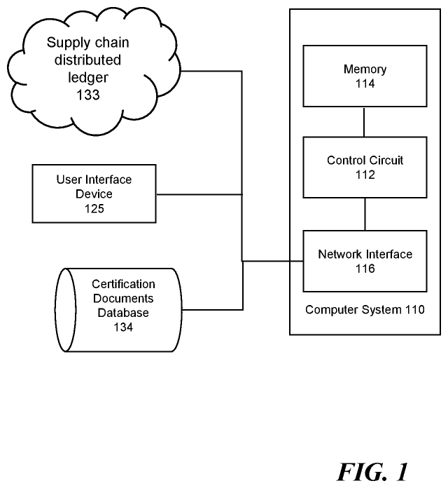

Referring now to FIG. 1, a system for product certification management is shown. The computer system 110 is coupled to a supply chain distributed ledger 133, a certification documents database 134, and a user interface device 125.

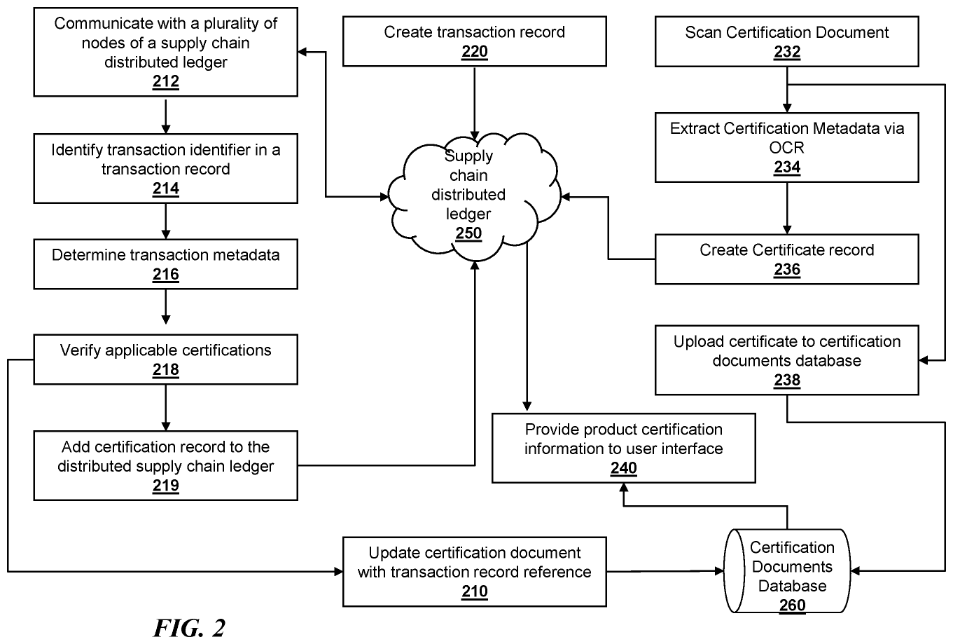

The computer system 110 comprises a control circuit 112, a memory 114, and a network interface device 116. The computer system 110 may comprise one or more of a server, a retailer backend system, a central computing system, a desktop computer system, and the like. The control circuit 112 may comprise a processor, a microprocessor, a central processing unit (CPU), a graphics processing unit (GPU), an application-specific integrated circuit (ASIC), and the like and may be configured to execute computer-readable instructions stored on a computer-readable storage memory 114. The computer-readable storage memory 114 may comprise volatile and/or non-volatile memory and have stored upon it, a set of computer-readable instructions which, when executed by the control circuit 112, causes the computer system 110 to verify and update certification information based on information stored in the supply chain distributed ledger 133 and the certification documents database 134. In some embodiments, the control circuit 112 may execute a program to function as a node of the supply chain distributed ledger 133 that verifies and updates the supply chain distributed ledger 133 collectively with one or more other nodes. In some embodiments, the computer-executable instructions may cause the control circuit 112 of the computer system 110 to execute a certification management module and perform one or more steps described with reference to FIGS. 2-4. In some embodiments, the computer-executable instructions may cause the control circuit 112 of the computer system 110 to provide a user interface for viewing product certification information. In some embodiments, the memory 114 may further store at least a portion of the supply chain distributed ledger 133 and/or the certification documents database 134.

The network interface device 116 may comprise a data port, a wired or wireless network adapter, and the like. In some embodiments, the computer system 110 may communicate with the user interface device 125, other nodes of the supply chain distributed ledger 133, and/or the certification documents database 134 over a network such as a local network, a private network, or the Internet. In some embodiments, the user interface device 125 may be a processor-based standalone user device with a storage memory device, such as a personal computer, a desktop computer, a laptop computer, a mobile device, a smartphone, and the like. The user interface device 125 may comprise user input/output devices such as a keyboard, a mouse, a touch screen, a display screen, a VR/AR display device, a speaker, a microphone, etc. The user interface device 125 may execute an application for accessing a GUI for interacting with the product information graphical user interface provided by the computer system 110. For example, the user interface device 125 may comprise a mobile phone running an application or a computer accessing a network site. A user may use the user interface device 125 to view product certification information based on the records stored in the supply chain distributed ledger 133.

The supply chain distributed ledger 133 comprises a distributed database comprising a plurality of nodes. In some embodiments, the supply chain distributed ledger comprises a plurality of certificate records recording certificate document information and metadata associated with the certification. In some embodiments, the certificate records may each be associated with an ESG certificate such as a fair-trade certificate, an organic farming certificate, a rainforest safe certificate, etc. In some embodiments, a certificate record further includes a pointer to a certificate document stored in the certification documents database 134. In some embodiments, certificate records may be added to the distributed database by a certificate issuing or rating agency or the recipient of the certification (e.g., farm, supplier, manufacturer, transportation service provider, whole seller, retailer, etc.). In some embodiments, the computer system 110 may provide, via the user interface device 125, a certification uploading user interface that receives the scanned certification document, performs optical character recognition (OCR), extracts metadata from the scanned document, create a certificate record in the supply chain distributed ledger, and upload the document to the certification documents database 134. In some embodiments, the certification metadata may comprise a date range (e.g., issue date and expiration date), an entity identifier, a source location, one or more ingredients, and/or one or more ingredient locations.

In some embodiments, the supply chain distributed ledger 133 comprises a plurality of transaction records recording transfers of physical items and/or services between two or more entities of a supply chain (e.g., farm, supplier, manufacturer, transportation service provider, whole seller, retailer, etc.). In some embodiments, a transaction record may include an entities identifier (e.g., farm region, processor name and location, supplier name and location, distribution identifier, and store identifier), a transfer date, a transfer location, and characteristics of the transferred product or service (e.g., origin, ingredients). In some embodiments, the transaction record may include references to one or more other transaction records, recording, for example, a prior transfer of the product or a product component. In some embodiments, the transaction record may further include references to certificate records associated with the products in the transaction. In some embodiments, a transaction record may be associated with a lot or batch of a specific product that traces back to a common source or sources, and have a unique lot or batch identifier. In some embodiments, each transaction record includes a lot number that is a unique identification number assigned to a certain quantity or groups of products from a single manufacturer, supplier, processor, or farm. Generally, products in a lot or batch are kept together in the supply chain until they are used to make another product or when they reach a retail location or an order fulfillment center.

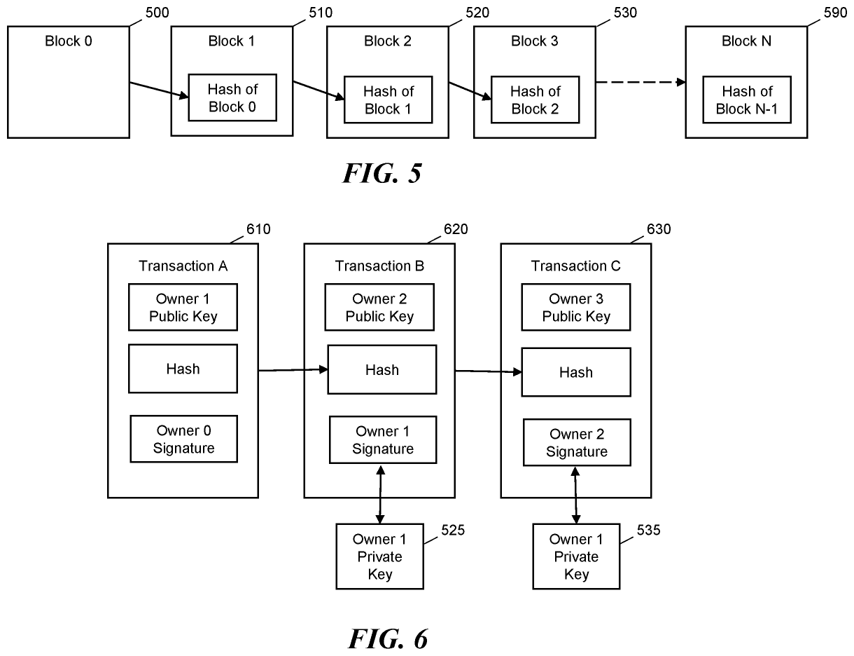

In some embodiments, the supply chain distributed ledger 133 may comprise a cryptographically verifiable ledger managed by a peer-to-peer network. In some embodiments, the supply chain distributed ledger 133 may comprise a blockchain database collectively verified and updated by computer systems associated with any number of entities in the supply chain functioning as nodes of the blockchain. For example, the blockchain may be updated and/or verified by retail stores, transporters, warehouses, distribution centers, suppliers, processors, manufacturers, farms, certification issuers, etc. In some embodiments, entities of the supply chain may add transaction records and/or certificate records to the blockchain as triggered by supply chain events associated with the entity and sign the update with its cryptographically verifiable signature. In some embodiments, the updates of the supply chain events may be automatically triggered at one or more computer systems by fulfillment of conditions in a smart contract and/or based on departure or arrival scans of products by a scanning device such as a camera, an optical code (e.g., barcode, QR code) reader, a radio frequency identification tag reader, etc. Other entities may collectively verify the update requests before each update becomes a permanent part of the blockchain record. Further details of a blockchain that may be used with the systems and methods described herein are described with reference to FIGS. 5-10.

The certification documents database 134 is a database configured to store certification documents. In some embodiments, certification documents may be stored as images/documents (e.g., in PDF format) and may include document metadata (e.g., issuer, upload entity, upload date, applicable dates, applicable product characteristics, etc.). In some embodiments, the certification documents database 134 may further record transaction record identifiers (e.g., block ID) associated with each scanned certification document and/or a certificate record identifier (e.g. block ID) associated with the scanned document. In some embodiments, the certification documents database comprises a network accessible shared/distributed database such as an interplanetary file system (IPFS).

While one computer system 110 is shown, in some embodiments, the functionalities of the computer system 110 may be implemented on a plurality of processor devices communicating on a network. In some embodiments, the computer system 110 may be coupled to a plurality of user interface devices 125 and simultaneously respond to any number of product certification queries from one or more user interface devices 125.

Referring now to FIG. 2, a method for product certification management is shown. In some embodiments, the steps shown in FIG. 2 may be performed by a processor-based device such as a control circuit executing a set of computer-readable instructions stored on a computer-readable memory. In some embodiments, one or more steps of FIG. 2 may be performed by the computer system 110 described with reference to FIG. 1 or a similar device.

In step 232, a certification document is scanned. In some embodiments, steps 232-238 may be performed by a certificate issuing entity (e.g., government or third-party agency) or by a supplier. In some embodiments, the system may provide a user interface to facilitate the uploading and recording of certification documents. For example, a supplier may scan a physical certification document received from a certificate issuer using an optical sensor such as a camera or a document scanner via the user interface. In some embodiments, step 232 may be performed by an optical image capture device such as a document scanner, a digital camera, and the like. In some embodiments, an existing digital document file (e.g., PDF) may be used and step 234 may be omitted. In step 234, the certification metadata is extracted from the document. In some embodiments, the metadata may be extracted based on an OCR algorithm. In some embodiments, the extracted metadata may be displayed via the user interface for verification, modification, and/or supplementation. In step 236, a certificate record is created and added to the supply chain distributed ledger 250 and in step 238, the certificate document is uploaded to a certification documents database 260. In some embodiments, the certificate record comprises a pointer to the certificate document stored in the certification documents database 260 and certification metadata determined in step 234. In some embodiments, the certificate record may be signed with a cryptographically verifiable signature of the certificate issuer and/or supplier.

In step 220, a transaction record is created and added to the supply chain distributed ledger 250. In some embodiments, a transaction record may be generated by an entity of a supply chain based on a supply chain event such as the transfer of ownership of a lot or batch of product from one entity to another. In some embodiments, the transaction record may be automatically generated with the fulfillment of conditions in a smart contract. For example, a transaction record may be generated when a retailer receives a shipment of a lot or batch from a supplier. In some embodiments, the transaction record may include references to one or more prior transaction records. In some embodiments, nodes of the supply chain distributed ledger 250 may collectively verify new transaction records based on the rules of the supply chain distributed ledger 250 prior to the record being accepted into the supply chain distributed ledger 250.

In step 212, the system communicates with the plurality of nodes of the supply chain distributed ledger as a node of the supply chain distributed ledger. In some embodiments, the plurality of nodes of the supply chain distributed ledger are managed by a plurality of entities in a supply chain such as farms, processors, suppliers, transportation providers, whole-sellers, distribution centers, retailers, and the like. In some embodiments, the supply chain distributed ledger may be the supply chain distributed ledger 133 described with reference to FIG. 1 herein. In some embodiments, the supply chain distributed ledger comprises a plurality of transaction records and a plurality of certificate records. In some embodiments, each transaction record is added by a supply chain entity associated with the supply chain event, such as the sender or a recipient of a shipment. In some embodiments, the supply chain distributed ledger may comprise a blockchain and the system may comprise a node of the blockchain as described with reference to FIGS. 5-10 herein. In some embodiments, the communications may include ledger updates, verifications, and/or ledger queries.

In step 214, the system identifies a transaction identifier in a transaction record. In some embodiments, the transaction record may be associated with a transfer of a product to a retailer and may be generated based on a smart contract in response to trigger conditions of the smart contract being met. In step 216, the system determines the transaction metadata. In some embodiments, transaction metadata may include one or more of product identifier (e.g., GTIN, UPC), product source(s), product source location(s), product ingredients, product manufacture/processor, product manufacture date, etc. In some embodiments, the transaction metadata may further specify one or more applicable certificates by referring to the associated certificate record(s) in the distributed ledger.

In step 218, the system verifies one or more applicable certifications for the transaction identifier based on the transaction metadata and the plurality of certificate records in the supply chain distributed ledger. In some embodiments, certificate records may each comprise certification metadata and a pointer to a certificate document stored in a certification documents database. The system may compare the transaction metadata with the certificate metadata to verify that the certificate is applicable to the transaction. For example, the system may verify that the product manufacture date of the products in the transaction falls within the date range of the certificate and/or the product contains the ingredient(s) specified in the certificate. In some embodiments, the system may verify one or more applicable certifications based on one or more prior transaction records referenced in the transaction record. For example, the system may inspect the supply chain of the products in a transaction using the distributed ledger to determine the dates and/or source locations of a product and/or its ingredient or component. In some embodiments, the system may further determine that each entity associated with products in a transaction, as recorded in the supply chain distributed record, meets the criteria of one or more certificates being verified. In some embodiments, the system verifies the one or more applicable certifications for the transaction identifier according to rules of a smart contract recorded in the supply chain distributed ledger 250. Upon the applicable certifications being verified, in step 219, the system adds a certificate verification record to the supply chain distributed ledger 250. In some embodiments, the certificate verification record may comprise adding a cryptographically verifiable signature of the entity associated with the product certification management module to the transaction record. In some embodiments, the certificate verification record may comprise references to the transaction record and the certificate record(s). In step 210, the system further adds a pointer to the certificate verification record or the transaction record to one or more certification documents associated with the one or more applicable certifications stored in the certification documents database 260. In some embodiments, steps 212-219 may be performed by a product certification management module of a verification entity, such as a retailer.

In step 240, the system provides a product certification information graphical user interface to users. The users may access the user interface with a user device and input a product identifier to look up verified certifications associated with one or more products. In some embodiments, a user may enter a product identifier by entering a product code or product name, capture an image on the product with a camera, scanning an optically readable code (e.g., barcode/QR code), etc. In some embodiments, the system may query the supply chain distributed ledger 250 for the transaction records, certificate records, and/or certification verification records associated with the inputted product identifier. In some embodiments, the user interface may be used by customers or ESG auditors to view certification compliance information associated with products and/or supply chain entities.

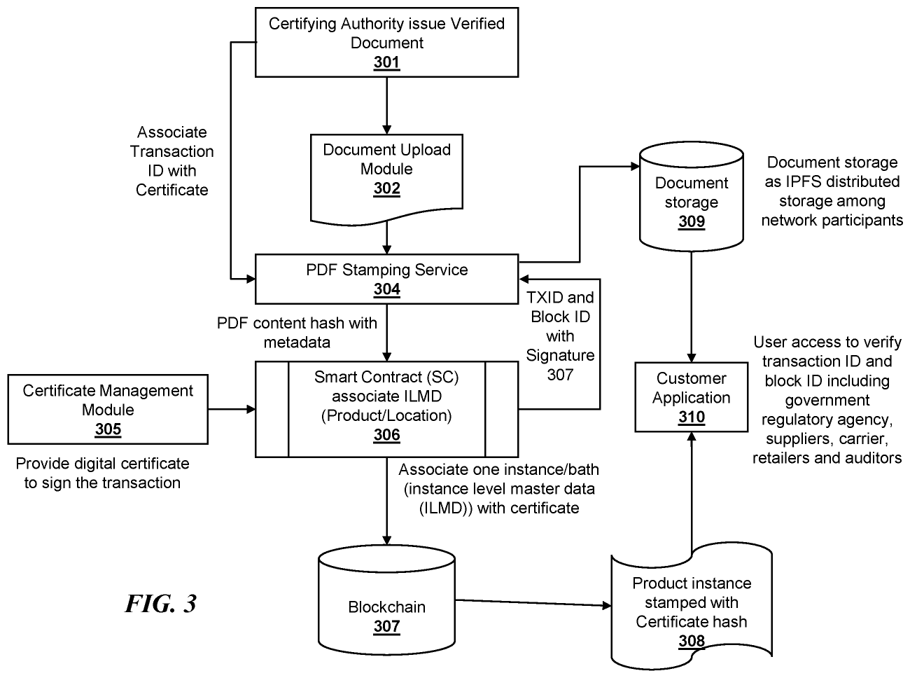

Referring now to FIG. 3, a process for product certificate management is shown. In some embodiments, the steps shown in FIG. 3 may be performed by a processor-based device such as a control circuit executing a set of computer-readable instructions stored on a computer-readable memory. In some embodiments, one or more steps of FIG. 3 may be performed by the computer system 110 described with reference to FIG. for a similar device.

In step 301, the certifying authority issues a certificate document and provide uploads the document through a document upload module 302. The certifying authority further associates a transaction ID with the certificate, and both the digital document and the transaction ID are provided to a PDF stamping service 304. The PDF stamping service 304 provides the PDF content hash with metadata to a smart contract 306. When a predefined condition of the smart contract is met, a certificate management module 305 provides a digital certificate the sign the transaction. In some embodiments, the certificate management module 305 may be associated with a retailer that sells products in the transaction to customers. The smart contract 306 then provides the transaction ID and block ID with the signature of the certificate management module 305 back to the PDF stamping service 304 which stamps the information to the PDF and stores the PDF to the document storage 309. In some embodiments, the document storage 309 may be a distributed storage that is maintained among network participants, such as an IPFS. The smart contract 306 further associates with one instance or batch (e.g., instant level master data (ILMD)) with the certificate in the blockchain database 307. In some embodiments, the blockchain database 307 may be the supply chain distributed ledger described herein. A customer application 310 provides a user interface that allows the user to access to verify transaction ID and block ID based on product instances stamped with certificate hash 308 in the blockchain database 307 and the documents stored in the document storage 309. In some embodiments, users of the user interface may include government regulatory agencies, suppliers, carriers, retailers, and auditors. In some embodiments, the user interface may be configured to display different information/reports based on user type and/or configuration.

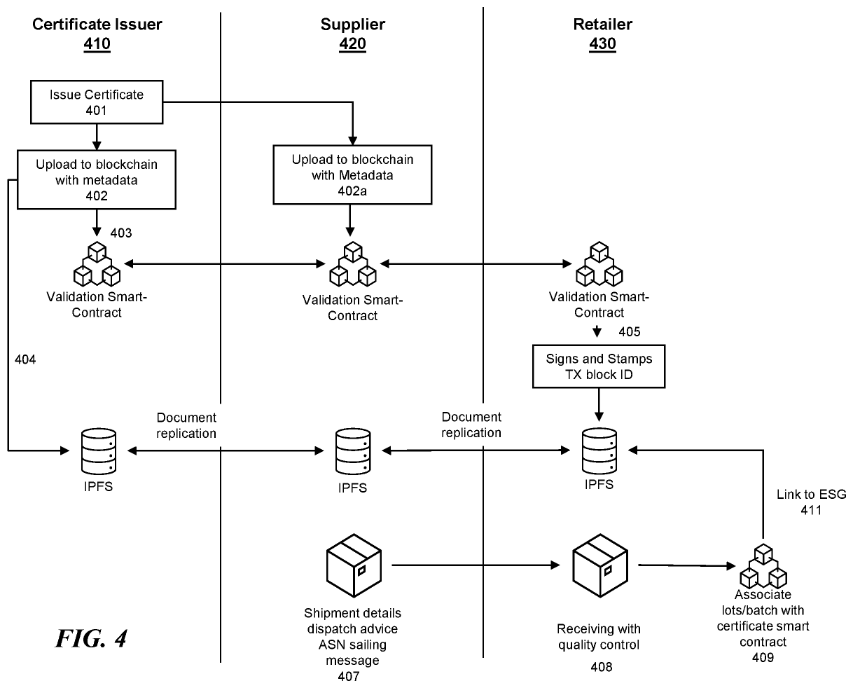

Referring now to FIG. 4, a process for product certificate management is shown. In some embodiments, the steps shown in FIG. 4 may be performed by processor-based devices such as a control circuit executing a set of computer-readable instructions stored on a computer-readable memory. In some embodiments, one or more steps of FIG. 4 may be performed by the computer system 110 described with reference to FIG. for a similar device.

FIG. 4 illustrates an example process involving a certificate issuer 410, a supplier 420, and a retailer 430. In step 401, the certificate issuer 410 issues a certificate. In step 402, the certificate information and the associated metadata are uploaded to a blockchain 403. The systems of the certificate issuer 410, the supplier 420, and the retailer 430, may each be configured to validate the update based on a predefined smart contract. In step 404, the certificate document is uploaded to an IPFS. The certificate issuer 410, the supplier 420, and the retailer may each be configured to replicate documents in an IPFS for distributed storage. In some embodiments, the supplier 420 may alternatively or additionally upload a received certificate with associated metadata to the blockchain in step 402a. In step 405, the retailer 430 signs and stamps a transaction block ID based on the records in the blockchain and adds the transaction block ID to the certificate document stored in the IPFS.

In step 407, the supplier ships a lot or batch to the retailer, and provides shipment details such as dispatch advice, advance ship notice (ASN), and sailing message to the retailer 430. In step 408, the retailer receives the shipment with quality control. In step 409, the retailer associated the lot or batch with the certificate based on the smart contract. In step 411, the lot or batch is linked to the certificates stored in the IPFS.

In some embodiments, with the systems and methods described herein, product and supply chain entity certification may be tracked and verified automatically via a distributed ledger such as a blockchain and a distributed document database. The automatic tracking and verification reduces the time and cost of certificate audits, and allows for more accurate and trusted information to be available to oversight agencies and customers.

Descriptions of some embodiments of blockchain technology are provided with reference to FIG. 5-10 herein. In some embodiments of the invention described above, blockchain technology may be utilized to record supply chain events and supply information for product certificate management. One or more of the systems associated with supply chain entities described herein may comprise a node in a distributed blockchain system storing a copy of the blockchain record. Updates to the blockchain may comprise supply chain events such as transfer of items from one supply chain entity to another and/or the processing of a product from one form to another (e.g., cases of tomato to salad kit) and one or more nodes on the system may be configured to incorporate one or more updates into blocks to add to the distributed database.

Distributed databases and shared ledger databases generally refer to databases based on peer-to-peer record-keeping and authentication in which records are kept at multiple nodes in the peer-to-peer network instead of kept at a trusted party. A blockchain may generally refer to a distributed database that maintains a growing list of records in which each block contains a hash of some or all previous records in the chain to secure the record from tampering and unauthorized revision. A hash generally refers to a derivation of original data. In some embodiments, the hash in a block of a blockchain may comprise a cryptographic hash that is difficult to reverse and/or a hash table. Blocks in a blockchain may further be secured by a system involving one or more of a distributed timestamp server, cryptography, public/private key authentication and encryption, proof standard (e.g., proof-of-work, proof-of-stake, proof-of-space), and/or other security, consensus, and incentive features. In some embodiments, a block in a blockchain may comprise one or more of a data hash of the previous block, a timestamp, a cryptographic nonce, a proof standard, and a data descriptor to support the security and/or incentive features of the system.

In some embodiments, a blockchain system comprises a distributed timestamp server comprising a plurality of nodes configured to generate computational proof of record integrity and the chronological order of its use for content, trade, and/or as a currency of exchange through a peer-to-peer network. In some embodiments, when a blockchain is updated, a node in the distributed timestamp server system takes a hash of a block of items to be timestamped and broadcasts the hash to other nodes on the peer-to-peer network. The timestamp in the block serves to prove that the data existed at the time in order to get into the hash. In some embodiments, each block includes the previous timestamp in its hash, forming a chain, with each additional block reinforcing the ones before it. In some embodiments, the network of timestamp server nodes performs the following steps to add a block to a chain: 1) new activities are broadcasted to all nodes, 2) each node collects new activities into a block, 3) each node works on finding a difficult proof-of-work for its block, 4) when a node finds a proof-of-work, it broadcasts the block to all nodes, 5) nodes accept the block only if activities are authorized, and 6) nodes express their acceptance of the block by working on creating the next block in the chain, using the hash of the accepted block as the previous hash. In some embodiments, nodes may be configured to consider the longest chain to be the correct one and work on extending it. A digital currency implemented on a blockchain system is described by Satoshi Nakamoto in “Bitcoin: A Peer-to-Peer Electronic Cash System” (http://bitcoin.org/bitcoin. pdf), the entirety of which is incorporated herein by reference.

Now referring to FIG. 5, an illustration of a blockchain according to some embodiments is shown. In some embodiments, a blockchain comprises a hash chain or a hash tree in which each block added in the chain contains a hash of the previous block. In FIG. 5, block 0 500 represents a genesis block of the chain. Block 1 510 contains a hash of block 0 500, block 2 520 contains a hash of block 1 510, block 3 530 contains a hash of block 2 520, and so forth. Continuing down the chain, block N 590 contains a hash of block N−1. In some embodiments, the hash may comprise the header of each block. Once a chain is formed, modifying or tampering with a block in the chain would cause detectable disparities between the blocks. For example, if block 1 is modified after being formed, block 1 would no longer match the hash of block 1 in block 2. If the hash of block 1 in block 2 is also modified in an attempt to cover up the change in block 1, block 2 would not then match with the hash of block 2 in block 3. In some embodiments, a proof standard (e.g., proof-of-work, proof-of-stake, proof-of-space, etc.) may be required by the system when a block is formed to increase the cost of generating or changing a block that could be authenticated by the consensus rules of the distributed system, making the tampering of records stored in a blockchain computationally costly and essentially impractical. In some embodiments, a blockchain may comprise a hash chain stored on multiple nodes as a distributed database and/or a shared ledger, such that modifications to any one copy of the chain would be detectable when the system attempts to achieve consensus prior to adding a new block to the chain. In some embodiments, a block may generally contain any type of data and record. In some embodiments, each block may comprise a plurality of transaction and/or activity records.

In some embodiments, blocks may contain rules and data for authorizing different types of actions and/or parties who can take action. In some embodiments, transaction and block forming rules may be part of the software algorithm on each node. When a new block is being formed, any node on the system can use the prior records in the blockchain to verify whether the requested action is authorized. For example, a block may contain a public key of an owner of an asset that allows the owner to show possession and/or transfer the asset using a private key. Nodes may verify that the owner is in possession of the asset and/or is authorized to transfer the asset based on prior transaction records when a block containing the transaction is being formed and/or verified. In some embodiments, rules themselves may be stored in the blockchain such that the rules are also resistant to tampering once created and hashed into a block. In some embodiments, the blockchain system may further include incentive features for nodes that provide resources to form blocks for the chain. For example, in the Bitcoin system, “miners' are nodes that compete to provide proof-of-work to form a new block, and the first successful miner of a new block earns Bitcoin currency in return.

Now referring to FIG. 6, an illustration of blockchain-based transactions according to some embodiments is shown. In some embodiments, the blockchain illustrated in FIG. 6 comprises a hash chain protected by private/public key encryption. Transaction A 610 represents a transaction recorded in a block of a blockchain showing that owner 1 (recipient) obtained an asset from owner 0 (sender). Transaction A 610 contains owner's 1 public key and owner 0's signature for the transaction and a hash of a previous block. When owner 1 transfers the asset to owner 2, a block containing transaction B 620 is formed. The record of transaction B 620 comprises the public key of owner 2 (recipient), a hash of the previous block, and owner 1's signature for the transaction that is signed with the owner 1's private key 625 and verified using owner 1's public key in transaction A 610. When owner 2 transfers the asset to owner 3, a block containing transaction C 630 is formed. The record of transaction C 630 comprises the public key of owner 3 (recipient), a hash of the previous block, and owner 2's signature for the transaction that is signed by owner 2's private key 635 and verified using owner 2's public key from transaction B 620. In some embodiments, when each transaction record is created, the system may check previous transaction records and the current owner's private and public key signature to determine whether the transaction is valid. In some embodiments, transactions may be broadcasted in the peer-to-peer network and each node on the system may verify that the transaction is valid prior to adding the block containing the transaction to their copy of the blockchain. In some embodiments, nodes in the system may look for the longest chain in the system to determine the most up-to-date transaction record to prevent the current owner from double-spending the asset. The transactions in FIG. 6 are shown as an example only. In some embodiments, a blockchain record and/or the software algorithm may comprise any type of rules that regulate who and how the chain may be extended. In some embodiments, the rules in a blockchain may comprise clauses of a smart contract that is enforced by the peer-to-peer network.

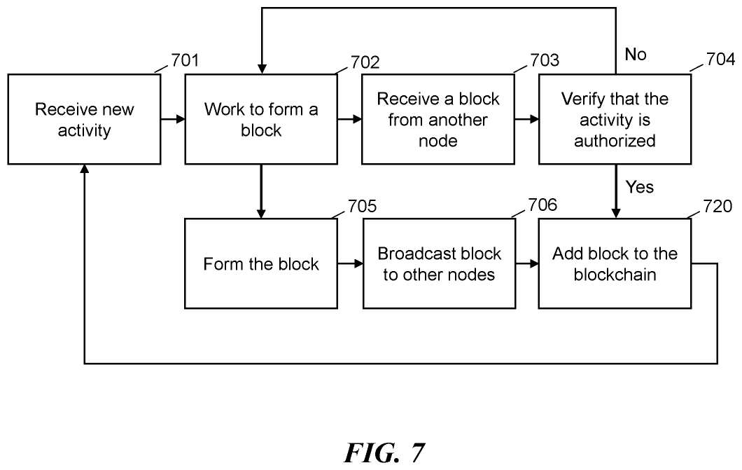

Now referring to FIG. 7, a flow diagram according to some embodiments is shown. In some embodiments, the steps shown in FIG. 7 may be performed by a processor-based device, such as a computer system, a server, a distributed server, a timestamp server, a blockchain node, and the like. In some embodiments, the steps in FIG. 7 may be performed by one or more of the nodes in a system using blockchain for record-keeping.

In step 701, a node receives a new activity. The new activity may comprise an update to the record being kept in the form of a blockchain. In some embodiments, for blockchain-supported digital or physical asset record-keeping, the new activity may comprise an asset transaction. In some embodiments, the new activity may be broadcasted to a plurality of nodes on the network prior to step 701. In step 702, the node works to form a block to update the blockchain. In some embodiments, a block may comprise a plurality of activities or updates and a hash of one or more previous blocks in the blockchain. In some embodiments, the system may comprise consensus rules for individual transactions and/or blocks and the node may work to form a block that conforms to the consensus rules of the system. In some embodiments, the consensus rules may be specified in the software program running on the node. For example, a node may be required to provide a proof standard (e.g., proof of work, proof of stake, etc.) which requires the node to solve a difficult mathematical problem to form a nonce in order to form a block. In some embodiments, the node may be configured to verify that the activity is authorized prior to working to form the block. In some embodiments, whether the activity is authorized may be determined based on records in the earlier blocks of the blockchain itself.

After step 702, if the node successfully forms a block in step 705 prior to receiving a block from another node, the node broadcasts the block to other nodes over the network in step 706. In some embodiments, in a system with incentive features, the first node to form a block may be permitted to add incentive payment to itself in the newly formed block. In step 720, the node then adds the block to its copy of the blockchain. In the event that the node receives a block formed by another node in step 703 prior to being able to form the block, the node works to verify that the activity recorded in the received block is authorized in step 704. In some embodiments, the node may further check the new block against system consensus rules for blocks and activities to verify whether the block is properly formed. If the new block is not authorized, the node may reject the block update and return to step 702 to continue to work to form the block. If the new block is verified by the node, the node may express its approval by adding the received block to its copy of the blockchain in step 720. After a block is added, the node then returns to step 701 to form the next block using the newly extended blockchain for the hash in the new block.

In some embodiments, in the event one or more blocks having the same block number is received after step 720, the node may verify the later arriving blocks and temporarily store these blocks if they pass verification. When a subsequent block is received from another node, the node may then use the subsequent block to determine which of the plurality of received blocks is the correct/consensus block for the blockchain system on the distributed database and update its copy of the blockchain accordingly. In some embodiments, if a node goes offline for a time period, the node may retrieve the longest chain in the distributed system, verify each new block added since it has been offline, and update its local copy of the blockchain prior to proceeding to step 701.

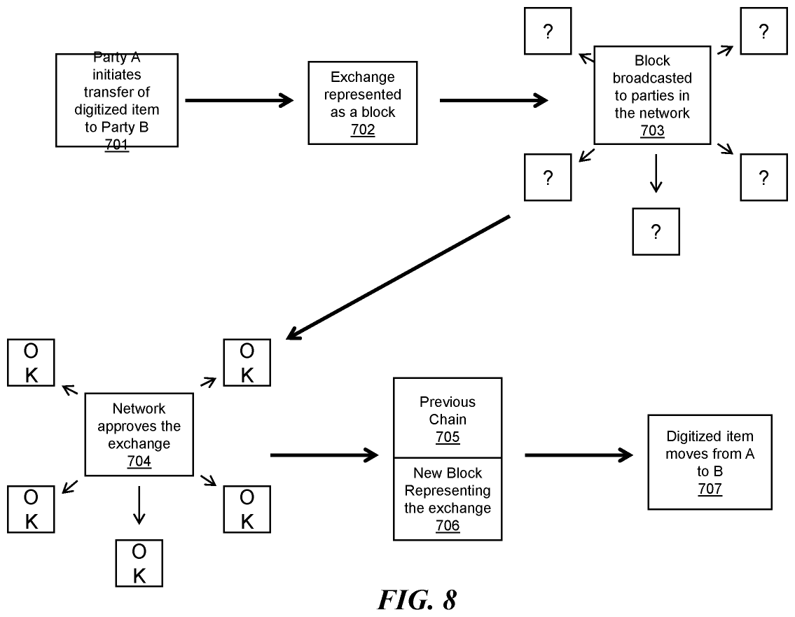

Now referring to FIG. 8, a process diagram a blockchain update according to some implementations is shown. In step 801, party A initiates the transfer of a digitized item to party B. In some embodiments, the digitized item may comprise a digital currency, a digital asset, a document, rights to a physical asset, etc. In some embodiments, Party A may prove that he has possession of the digitized item by signing the transaction with a private key that may be verified with a public key in the previous transaction of the digitized item. In step 802, the exchange initiated in step 801 is represented as a block. In some embodiments, the transaction may be compared with transaction records in the longest chain in the distributed system to verify part A's ownership. In some embodiments, a plurality of nodes in the network may compete to form the block containing the transaction record. In some embodiments, nodes may be required to satisfy proof-of-work by solving a difficult mathematical problem to form the block. In some embodiments, other methods of proof such as proof-of-stake, proof-of-space, etc. may be used in the system. In some embodiments, the node that is first to form the block may earn a reward for the task as incentive. For example, in the Bitcoin system, the first node to provide proof of work for a block may earn a Bitcoin. In some embodiments, a block may comprise one or more transactions between different parties that are broadcasted to the nodes. In step 803, the block is broadcasted to parties in the network. In step 804, nodes in the network approve the exchange by examining the block that contains the exchange. In some embodiments, the nodes may check the solution provided as proof-of-work to approve the block. In some embodiments, the nodes may check the transaction against the transaction record in the longest blockchain in the system to verify that the transaction is valid (e.g., party A is in possession of the asset he/she s seeks to transfer). In some embodiments, a block may be approved with consensus of the nodes in the network. After a block is approved, the new block 806 representing the exchange is added to the existing chain 805 comprising blocks that chronologically precede the new block 806. The new block 806 may contain the transaction(s) and a hash of one or more blocks in the existing chain 805. In some embodiments, each node may then update their copy of the blockchain with the new block and continue to work on extending the chain with additional transactions. In step 807, when the chain is updated with the new block, the digitized item is moved from party A to party B.

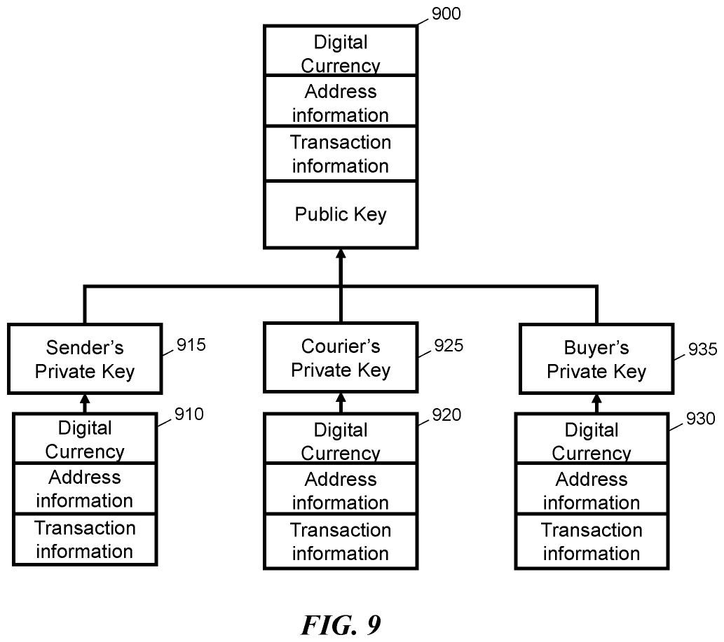

Now referring to FIG. 9, a diagram of a blockchain according to some embodiments in shown. FIG. 9 comprises an example of an implementation of a blockchain system for delivery service record keeping. The delivery record 900 comprises digital currency information, address information, transaction information, and a public key associated with one or more of a sender, a courier, and a buyer. In some embodiments, nodes associated with the sender, the courier, and the buyer may each store a copy of the delivery records 910, 920, and 930 respectively. In some embodiments, the delivery record 900 comprises a public key that allows the sender, the courier, and/or the buyer to view and/or update the delivery record 900 using their private keys 915, 925, and 935 respectively. For example, when a package is transferred from a sender to the courier, the sender may use the sender's private key 915 to authorize the transfer of a digital asset representing the physical asset from the sender to the courier and update the delivery record with the new transaction. In some embodiments, the transfer from the seller to the courier may require signatures from both the sender and the courier using their respective private keys. The new transaction may be broadcasted and verified by the sender, the courier, the buyer, and/or other nodes on the system before being added to the distributed delivery record blockchain. When the package is transferred from the courier to the buyer, the courier may use the courier's private key 925 to authorize the transfer of the digital asset representing the physical asset from the courier to the buyer and update the delivery record with the new transaction. In some embodiments, the transfer from the courier to the buyer may require signatures from both the courier and the buyer using their respective private keys. The new transaction may be broadcasted and verified by the sender, the courier, the buyer, and/or other nodes on the system before being added to the distributed delivery record blockchain.

With the scheme shown in FIG. 9, the delivery record may be updated by one or more of the sender, courier, and the buyer to form a record of the transaction without a trusted third party while preventing unauthorized modifications to the record. In some embodiments, the blockchain-based transactions may further function to include transfers of digital currency with the completion of the transfer of physical assets. With the distributed database and peer-to-peer verification of a blockchain system, the sender, the courier, and the buyer can each have confidence in the authenticity and accuracy of the delivery record stored in the form of a blockchain.

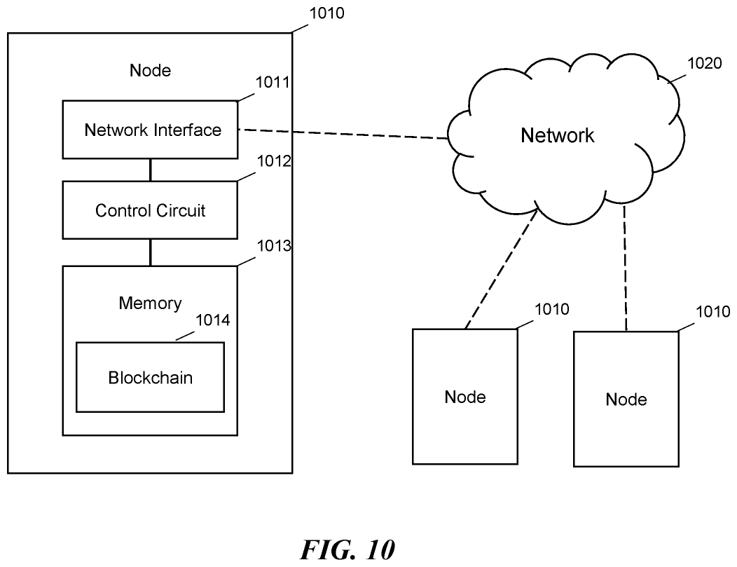

Now referring to FIG. 10, a system according to some embodiments is shown. A distributed blockchain system comprises a plurality of nodes 1010 communicating over a network 1020. In some embodiments, the nodes 1010 may comprise a distributed blockchain server and/or a distributed timestamp server. In some embodiments, one or more nodes 1010 may comprise or be similar to a “miner” device on the Bitcoin network. Each node 1010 in the system comprises a network interface 1011, a control circuit 1012, and a memory 1013.

The control circuit 1012 may comprise a processor, a microprocessor, and the like and may be configured to execute computer readable instructions stored on a computer readable storage memory 1013. The computer readable storage memory may comprise volatile and/or non-volatile memory and have stored upon it a set of computer readable instructions which, when executed by the control circuit 1012, causes the node 1010 to update the blockchain 1014 stored in the memory 1013 based on communications with other nodes 1010 over the network 1020. In some embodiments, the control circuit 1012 may further be configured to extend the blockchain 1014 by processing updates to form new blocks for the blockchain 1014. Generally, each node may store a version of the blockchain 1014, and together, may form a distributed database. In some embodiments, each node 1010 may be configured to perform one or more steps described with reference to FIGS. 10-11 herein.

The network interface 1011 may comprise one or more network devices configured to allow the control circuit to receive and transmit information via the network 1020. In some embodiments, the network interface 1011 may comprise one or more of a network adapter, a modem, a router, a data port, a transceiver, and the like. The network 1020 may comprise a communication network configured to allow one or more nodes 1010 to exchange data. In some embodiments, the network 1020 may comprise one or more of the Internet, a local area network, a private network, a virtual private network, a home network, a wired network, a wireless network, and the like. In some embodiments, the system does not include a central server and/or a trusted third-party system. Each node in the system may enter and leave the network at any time.

With the system and processes shown in, once a block is formed, the block cannot be changed without redoing the work to satisfy census rules thereby securing the block from tampering. A malicious attacker would need to provide a proof standard for each block subsequent to the one he/she seeks to modify, race all other nodes, and overtake the majority of the system to affect change to an earlier record in the blockchain.

In some embodiments, blockchain may be used to support a payment system based on cryptographic proof instead of trust, allowing any two willing parties to transact directly with each other without the need for a trusted third party. Bitcoin is an example of a blockchain-backed currency. A blockchain system uses a peer-to-peer distributed timestamp server to generate computational proof of the chronological order of transactions. Generally, a blockchain system is secure as long as honest nodes collectively control more processing power than any cooperating group of attacker nodes. With a blockchain, the transaction records are computationally impractical to reverse. As such, sellers are protected from fraud and buyers are protected by the routine escrow mechanism.

In some embodiments, a blockchain may use to secure digital documents such as digital cash, intellectual property, private financial data, chain of title to one or more rights, real property, digital wallet, digital representation of rights including, for example, a license to intellectual property, digital representation of a contractual relationship, medical records, security clearance rights, background check information, passwords, access control information for physical and/or virtual space, and combinations of one or more of the foregoing that allows online interactions directly between two parties without going through an intermediary. With a blockchain, a trusted third party is not required to prevent fraud. In some embodiments, a blockchain may include peer-to-peer network timestamped records of actions such as accessing documents, changing documents, copying documents, saving documents, moving documents, or other activities through which the digital content is used for its content, as an item for trade, or as an item for remuneration by hashing them into an ongoing chain of hash-based proof-of-work to form a record that cannot be changed in accord with that timestamp without redoing the proof-of-work.

In some embodiments, in the peer-to-peer network, the longest chain proves the sequence of events witnessed, proves that it came from the largest pool of processing power, and that the integrity of the document has been maintained. In some embodiments, the network for supporting blockchain-based record keeping requires minimal structure. In some embodiments, messages for updating the record are broadcast on a best-effort basis. Nodes can leave and rejoin the network at will and may be configured to accept the longest proof-of-work chain as proof of what happened while they were away.

In some embodiments, a blockchain-based system allows content use, content exchange, and the use of the content for remuneration based on cryptographic proof instead of trust, allowing any two willing parties to employ the content without the need to trust each other and without the need for a trusted third party. In some embodiments, a blockchain may be used to ensure that a digital document was not altered after a given timestamp, that alterations made can be followed to a traceable point of origin, that only people with authorized keys can access the document, that the document itself is the original and cannot be duplicated, that where duplication is allowed and the integrity of the copy is maintained along with the original, that the document creator was authorized to create the document, and/or that the document holder was authorized to transfer, alter, or otherwise act on the document.

As used herein, in some embodiments, the term blockchain may refer to one or more of a hash chain, a hash tree, a distributed database, and a distributed ledger. In some embodiments, blockchain may further refer to systems that use one or more of cryptography, private/public key encryption, proof standard, distributed timestamp server, and inventive schemes to regulate how new blocks may be added to the chain. In some embodiments, blockchain may refer to the technology that underlies the Bitcoin system, a “sidechain” that uses the Bitcoin system for authentication and/or verification, or an alternative blockchain (“altchain”) that is based on bitcoin concept and/or code but are generally independent of the Bitcoin system.

Descriptions of embodiments of blockchain technology are provided herein as illustrations and examples only. The concepts of the blockchain system may be variously modified and adapted for different applications.

In one embodiment, a system for product certification management comprises a network interface, a user interface device, and a control circuit coupled to the network interface and the user interface device. The control circuit executes a product certification management module that is configured to communicate, as a node of a supply chain distributed ledger and via the network interface, with a plurality of other nodes of the supply chain distributed ledger corresponding to a plurality of entities in a supply chain, wherein the supply chain distributed ledger comprises a plurality of transaction records and a plurality of certificate records, identify a transaction identifier in a transaction record in the supply chain distributed ledger, retrieve transaction metadata associated with the transaction identifier from the supply chain distributed ledger, verify one or more applicable certifications for the transaction identifier based on the transaction metadata and the plurality of certificate records in the supply chain distributed ledger, the plurality of certificate records each comprising certification metadata and a pointer to a certificate document stored in a certification documents database, and generate, as an update to the supply chain distributed ledger, a certificate verification record comprising a reference to the transaction record and a reference to one or more certificate records associated with the one or more applicable certifications.

In one embodiment, a method for product certification management comprises communicating, as a node of a supply chain distributed ledger and via a network interface, with a plurality of other nodes of the supply chain distributed ledger corresponding to a plurality of entities in a supply chain, wherein the supply chain distributed ledger comprises a plurality of transaction records and a plurality of certificate records, identifying, with a control circuit executing a product certification management module, a transaction identifier in a transaction record in the supply chain distributed ledger, retrieving, with the control circuit, transaction metadata associated with the transaction identifier from the supply chain distributed ledger, verifying, with the control circuit, one or more applicable certifications for the transaction identifier based on the transaction metadata and the plurality of certificate records in the supply chain distributed ledger, the plurality of certificate records each comprising certification metadata and a pointer to a certificate document stored in a certification documents database, and generating, with the control circuit and as an update to the supply chain distributed ledger, a certificate verification record comprising a reference to the transaction record and a reference to one or more certificate records associated with the one or more applicable certifications.

Those skilled in the art will recognize that a wide variety of other modifications, alterations, and combinations can also be made with respect to the above-described embodiments without departing from the scope of the invention, and that such modifications, alterations, and combinations are to be viewed as being within the ambit of the inventive concept.

What is claimed is:

1. A system for product certification management, the system comprises:
a network interface;
a user interface device; and
a control circuit coupled to the network interface and the user interface device, the control circuit executing a product certification management module configured to:
communicate, as a node of a supply chain distributed ledger and via the network interface, with a plurality of other nodes of the supply chain distributed ledger corresponding to a plurality of entities in a supply chain, wherein the supply chain distributed ledger comprises a plurality of transaction records and a plurality of certificate records;
identify a transaction identifier in a transaction record in the supply chain distributed ledger;
retrieve transaction metadata associated with the transaction identifier from the supply chain distributed ledger;
verify one or more applicable certifications for the transaction identifier based on the transaction metadata and the plurality of certificate records in the supply chain distributed ledger, the plurality of certificate records each comprising certification metadata and a pointer to a certificate document stored in a certification documents database; and
generate, as an update to the supply chain distributed ledger, a certificate verification record comprising a reference to the transaction record and a reference to one or more certificate records associated with the one or more applicable certifications.

2. The system of claim 1, wherein a certificate record of the plurality of certificate records is added to the supply chain distributed ledger by another node of the supply chain by scanning a physical certification document and storing the scanned certification document to the certification documents database.

3. The system of claim 2, wherein the certification metadata of the certificate record are extracted based on performing optical text recognition on the scanned certification document.

4. The system of claim 1, wherein the certification metadata comprise a date range, an entity identifier, a source location, one or more ingredients, and/or one or more ingredient locations.

5. The system of claim 1, wherein the product certification management module further verifies the one or more applicable certifications based on one or more prior transaction records referenced in the transaction record.

6. The system of claim 1, wherein the product certification management module is further configured to add a pointer to the certificate verification record or the transaction record to one or more certification documents associated with the one or more applicable certifications stored in the certification documents database.

7. The system of claim 1, wherein the control circuit is further configured to: provide a product information graphical user interface to a plurality of users, wherein the product information graphical user interface is configured receive the transaction identifier and display certificates applicable to the transaction identifier based on the one or more applicable certifications referenced in the certificate verification record.

8. The system of claim 1, wherein the certificate verification record further comprises a cryptographically verifiable signature of an entity associated with the product certification management module.

9. The system of claim 1, wherein the certification documents database comprises an interplanetary file system (IPFS).

10. The system of claim 1, wherein the product certification management module verifies the one or more applicable certifications for the transaction identifier according to rules of a smart contract recorded in the supply chain distributed ledger.

11. A method for product certification management, the method comprises:
communicating, as a node of a supply chain distributed ledger and via a network interface, with a plurality of other nodes of the supply chain distributed ledger corresponding to a plurality of entities in a supply chain, wherein the supply chain distributed ledger comprises a plurality of transaction records and a plurality of certificate records;
identifying, with a control circuit executing a product certification management module, a transaction identifier in a transaction record in the supply chain distributed ledger;
retrieving, with the control circuit, transaction metadata associated with the transaction identifier from the supply chain distributed ledger;
verifying, with the control circuit, one or more applicable certifications for the transaction identifier based on the transaction metadata and the plurality of certificate records in the supply chain distributed ledger, the plurality of certificate records each comprising certification metadata and a pointer to a certificate document stored in a certification documents database; and
generating, with the control circuit and as an update to the supply chain distributed ledger, a certificate verification record comprising a reference to the transaction record and a reference to one or more certificate records associated with the one or more applicable certifications.

12. The method of claim 11, wherein a certificate record of the plurality of certificate records is added to the supply chain distributed ledger by another node of the supply chain by scanning a physical certification document and storing the scanned certification document to the certification documents database.

13. The method of claim 12, wherein the certification metadata of the certificate record are extracted based on performing optical text recognition on the scanned certification document.

14. The method of claim 11, wherein the certification metadata comprise a date range, an entity identifier, a source location, one or more ingredients, and/or one or more ingredient locations.

15. The method of claim 11, the one or more applicable certifications are verified further based on one or more prior transaction records referenced in the transaction record.

16. The method of claim 11, further comprising:
adding a pointer to the certificate verification record or the transaction record to one or more certification documents associated with the one or more applicable certifications stored in the certification documents database.

17. The method of claim 11, further comprising:
providing a product information graphical user interface to a plurality of users, wherein the product information graphical user interface is configured receive the transaction identifier and display certificates applicable to the transaction identifier based on the one or more applicable certifications referenced in the certificate verification record.

18. The method of claim 11, wherein the certificate verification record further comprises a cryptographically verifiable signature of an entity associated with the product certification management module.

19. The method of claim 11, wherein the certification documents database comprises an interplanetary file system (IPFS).

20. The method of claim 11, verifying the one or more applicable certifications for the transaction identifier is performed by the product certification management module according to rules of a smart contract recorded in the supply chain distributed ledger.
